(19) United States
(12) Patent Application Publication
(10) Pub. No.: US 2007/0241163 A1
(43) Pub. Date: Oct. 18, 2007

(54) Apparatus And Method For Friction Stir Spot Welding

(76) Inventors: Michael E. Valant, Dallas, TX (US); Radovan Kovacevic, Plano, TX (US)

Correspondence Address: BAKER BOTTS L.L.P., 2001 ROSS AVENUE, SUITE 600, DALLAS, TX, 75201-2980, US

(21) Appl. No.: 11/279,908

(22) Filed: Apr. 17, 2006

(51) Int. Cl. B23K 20/12; B23K 37/00

(52) U.S. Cl. 228/2.1; 228/112.1

(57) ABSTRACT

An apparatus for welding a workpiece has a welding head and a rotating tool. The welding head has a recessed portion and a welding head end to be placed in contact with a surface of the workpiece. The rotating tool is disposed within the recessed portion of the welding head. The rotating tool is operable to rotate about an axis and to translate along the axis. The rotating tool comprises a rotating tool end to be placed in contact with material of the workpiece. The rotating tool end comprises a shoulder and one or more off-center protrusions. The shoulder has a surface operable to frictionally heat the material of the workpiece. An off-center protrusion is operable to penetrate and displace the material of the workpiece to form a weld.

### TECHNICAL FIELD

This invention relates in general to welding and, more particularly, to an apparatus and a method for friction stir spot welding.

### BACKGROUND

Welding systems are used to join parts of a workpiece. Known friction stir spot welding (FSSW) systems use a rotating tool to join workpiece parts. The rotating tool includes a pin centered on a shoulder. As the tool rotates, the pin penetrates the material of the workpiece, while the shoulder comes in contact with the workpiece. Friction between the shoulder and the workpiece heats the material, causing the material to plasticize and form a weld. These known systems, however, do not yield satisfactory welds in certain situations.

### SUMMARY OF THE DISCLOSURE

The present invention provides an apparatus and method for spot welding that substantially reduces or eliminates at least some of the disadvantages and problems associated with previous methods and systems.

In accordance with some embodiments, an apparatus for welding a workpiece has a welding head and a rotating tool. The welding head has a recessed portion and a welding head end to be placed in contact with a surface of the workpiece. The rotating tool is disposed within the recessed portion of the welding head. The rotating tool is operable to rotate about an axis and to translate along the axis. The rotating tool comprises a rotating tool end to be placed in contact with material of the workpiece. The rotating tool end comprises a shoulder and one or more off-center protrusions. The shoulder has a surface operable to frictionally heat the material of the workpiece. An off-center protrusion is operable to penetrate and displace the material of the workpiece to form a weld.

In accordance with some embodiments, a method of welding a workpiece includes placing a welding head end of a welding head in contact with material of the workpiece. A shoulder of a rotating tool end of a rotating tool is placed in contact with the material of the workpiece, where the rotating tool is disposed within a recessed portion of the welding head. The material of the workpiece is frictionally heated using the shoulder. The material of the workpiece is displaced using one or more off-center protrusions of the rotating tool end to form a weld.

Certain embodiments of the invention may provide one or more technical advantages. A technical advantage of an embodiment may be that a welding apparatus includes a rotating tool with off-center protrusions. The off-center protrusions may increase the contact area between the rotating tool and the workpiece, which may allow for faster plasticization of displaced workpiece material. The off-center protrusions may also increase the volume of bonded material common to both of the elements which are welded, resulting in a weld with improved mechanical properties.

Another technical advantage of an embodiment may be that a welding head of the welding apparatus may rotate during removal of the welding apparatus from the workpiece. Rotating the welding head may break a mechanical bond formed between the welding head and the workpiece by displaced material, which may allow for easier removal. Another technical advantage of an embodiment may be that the welding head may be used to flatten the weld to yield a lower profile weld.

Another technical advantage of an embodiment may be that rotation of the rotating tool may continue during removal of the rotating tool from the workpiece. Continuing rotation may require less additional force to separate the rotating tool from the workpiece. Another technical advantage of an embodiment may be that rotation of the rotating tool may be stopped prior to removal of the rotating tool from the workpiece. Stopping rotation may reduce removal of displaced material from the workpiece, which may yield a stronger weld.

Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 is an illustration of a welding system for friction stir spot welding that may be used to weld a workpiece, in accordance with an embodiment of the invention;

FIG. 2 is a cross section of an example welding apparatus that may be used with the welding system of FIG. 1, in accordance with an embodiment of the invention;

FIG. 3 is an illustration of an example rotating tool that may be used with the welding apparatus of FIG. 2, in accordance with an embodiment of the invention; and

FIG. 4 is an illustration of a method of friction stir spot welding that may be used by the welding apparatus of FIG. 2, in accordance with an embodiment of the invention.

### DETAILED DESCRIPTION OF THE INVENTION

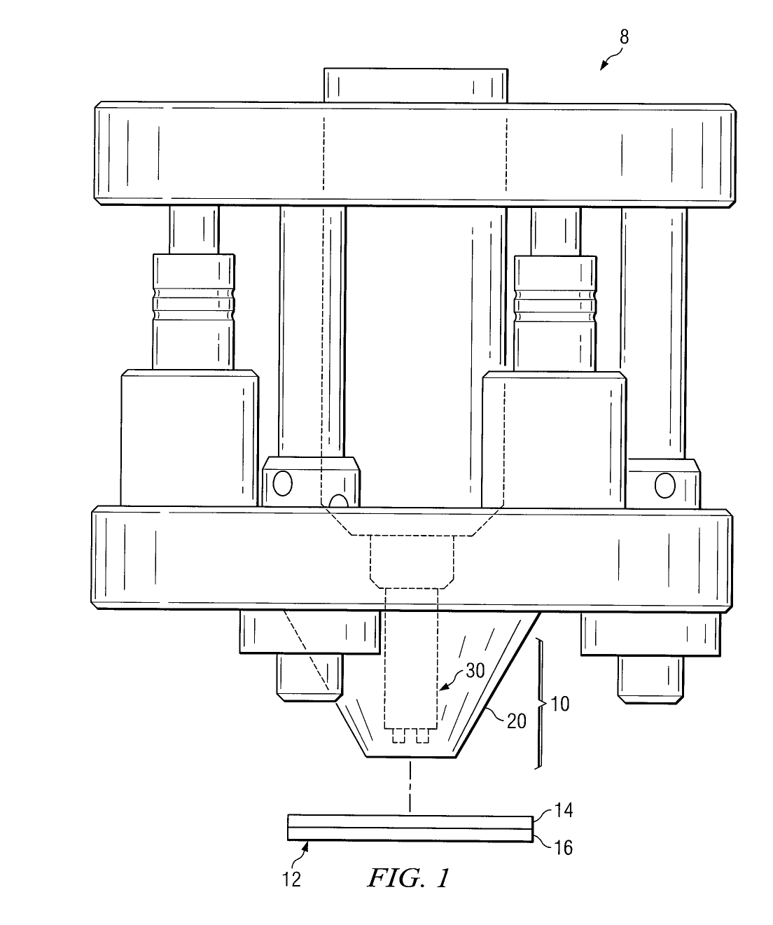

FIG. 1 is an illustration of a welding system 8 for friction stir spot welding that may be used to weld a workpiece 12, in accordance with an embodiment of the invention. Welding system 8 includes a welding apparatus 10 with a welding head 20 and a rotating tool 30 coupled as shown.

According to one embodiment of operation, welding apparatus 10 moves towards workpiece 12 until off-center protrusions of rotating tool 30 penetrate workpiece 12. The off-center protrusions stir the material of workpiece 12, while rotating tool 30, other parts of welding apparatus 10, and workpiece 12 contain displaced material to form a spot weld. The off-center protrusions may increase the contact area between rotating tool 30 and the workpiece 12, which may allow for faster plasticization of the workpiece material.

In the illustrated embodiment, workpiece 12 may represent any suitable workpiece that may be joined by friction stir spot welding. For example, workpiece 12 may represent metal sheets used to manufacture automobiles. Workpiece 12 may comprise any suitable material, for example, a metal such as aluminum or an aluminum alloy.

Workpiece 12 may include one or more layers to be welded. The layers may be flat or have any suitable curvature. In the illustrated embodiment, workpiece 12 includes a layer 14 to be welded to a layer 16, where layer 14 is disposed outwardly from layer 16. Each layer may have any suitable thickness, for example, 1 to 4 millimeters (mm), such as 2 to 3 mm.

Welding system 8 provides appropriate movement to welding head 20 and rotating tool 30 of welding apparatus 10. In one embodiment, welding system 8 may translate welding head 20 and rotating tool 30 towards and away from workpiece 12. Welding system 8 may rotate rotating tool 30, and may also rotate welding head 20.

According to one embodiment, welding system 8 may operate using any suitable welding parameters. As an example, the rotational speed describes the speed of rotation of rotating tool 30. In one embodiment, the rotational speed of rotating tool 30 may be selected to be sufficiently fast to allow for sufficient mixing, but sufficiently slow to prevent displaced material from flowing out of weld. For example, the rotational speed may be 500 to 4000 rotations per minute (rpm), such as 800 to 3000 rpm, for example, approximately 1200 rpm.

As another example, the plunging speed describes the speed of the penetration of rotating tool 30 into the material of workpiece 12. In one embodiment, the plunging speed of rotating tool 30 may be 25 to 150 millimeters per minute (mm/min), for example, approximately 25 mm/min. A lower plunging speed may yield a stronger weld.

As yet another example, the plunge depth describes the depth of the penetration of rotating tool 30 into the material of workpiece 12. In one embodiment, the plunge depth of rotating tool 30 may be 0.8 to 1.8 mm, for example, approximately 1.8 mm. Deeper penetration may yield more flow of material near faying surfaces, which may result in a stronger weld.

Modifications, additions, or omissions may be made to welding system 8 without departing from the scope of the invention. The components of welding system 8 may be integrated or separated according to particular needs. Moreover, the operations of welding system 8 may be performed by more, fewer, or other components. Additionally, operations of welding system 8 may be performed using any suitable device, mechanism, structure, or any suitable combination of the preceding.

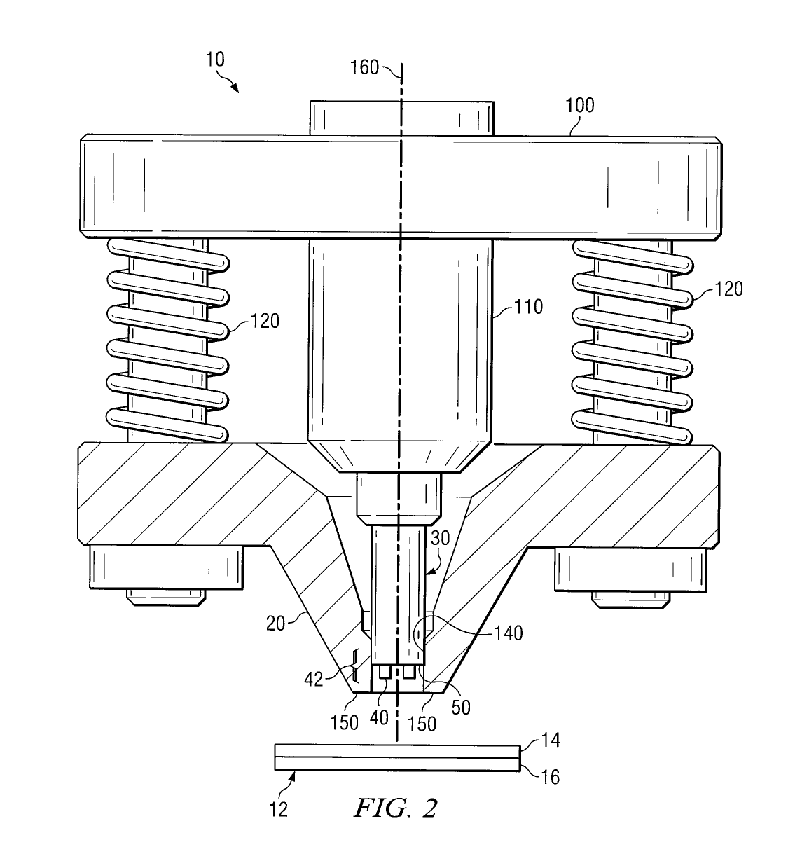

FIG. 2 is a cross section of an example welding apparatus 10 that may be used with welding system 8 of FIG. 1, in accordance with an embodiment of the invention. Welding apparatus 10 is operable to facilitate movement of welding head 20 and rotating pin 30 to form a spot weld on workpiece 12. Welding apparatus 10 may facilitate translation of welding head 20 and rotating pin 30 towards and away from workpiece 12, and may facilitate rotation of rotating pin 30 and welding head 20.

In the illustrated embodiment, welding apparatus 10 includes a base member 100, an actuator 110, one or more force mechanisms 120, welding head 20, and rotating pin 30 coupled as shown. The components of welding apparatus 10 may comprise any suitable material, for example, a metal such as stainless steel.

According to one embodiment of operation, welding apparatus 10 moves welding head 20 and rotating tool 30 towards workpiece 12 until off-center protrusions of rotating tool 30 penetrate workpiece 12. The off-center protrusions stir the material of workpiece 12, while rotating tool 30, welding head 20, and workpiece 12 contain displaced material. The trapped material rotates and plasticizes, which forms a weld.

In the illustrated embodiment, base member 100 provides support for welding apparatus 10, and may be used to couple force mechanisms 120 and welding head 20 to the rest of welding system 8. Base member 100 may also facilitate movement of welding head 20 or rotating tool 30 or both. In the illustrated embodiment, base member 100 facilitates translation of welding head 20 or rotating tool 30 or both towards and away from workpiece 12, and may facilitate rotation of welding head 20 about an axis 160.

Force mechanisms 120 apply force to facilitate appropriate movement of welding head 20 and rotating tool 30. In the illustrated embodiment, a force mechanism 120 comprises a spring. As welding head 20 comes into contact with the surface of workpiece 12, force mechanisms 120 compress to allow rotating tool 30 to continue to move towards workpiece 12. Force mechanisms 120 apply a force to the surface of workpiece 12 to allow welding head 20, rotating tool 30, and the surface of workpiece 12 to substantially contain material displaced by rotating tool 30. Force mechanisms 120 may also apply a force to the surface of workpiece 12 that allows welding head 20 and rotating tool 30 to be readily removed from the surface of workpiece 12.

In one embodiment, force mechanisms 120 may be selected to sufficiently compress to allow rotating tool 30 to continue to move towards workpiece 12, while applying sufficient force to the surface of workpiece 12 to allow the material displaced by rotating tool 30 to be contained.

Welding head 20 comes into contact with workpiece 12, and facilitates containment of material displaced by rotating tool 30. In the illustrated embodiment, welding head 20 includes a welding head end 150 and a recessed portion 140. Welding head end 150 comes into contact with the surface of workpiece 12. Recessed portion 140 facilitates containment of material displaced by rotating tool 30. In one embodiment, welding head 20 may have an annular shape, where recessed portion 140 forms the opening of the annular shape. Welding head end 150 may be extended, and have a substantially flat surface that conforms to the surface of workpiece 12.

In some embodiments, a hammering device may be used to flatten the weld after the weld has been formed. The hammering device may comprise force mechanism 120 and welding head 20.

Actuator 110 facilitates movement of rotating tool 30, and may be used to couple rotating tool 30 to the rest of welding system 8. In the illustrated embodiment, actuator 110 facilitates rotation of rotating tool 30 about axis 160, and may facilitate translation of rotating tool 30 towards and away from workpiece 12 along axis 160.

Rotating tool 30 penetrates, stirs, and heats a portion of the material of workpiece 12 to create a weld. Typically, the portion include a portion of each layer 14 and 16 of workpiece 12. In the illustrated embodiment, rotating tool 30 is disposed within recessed portion 140 of welding head 20, and rotates about axis 160.

In the illustrated embodiment, rotating tool 30 includes a rotating tool end 42 that penetrates workpiece 12. Rotating tool end 42 has a surface suitable for contacting, penetrating, stirring, and heating the material of workpiece 12. In the illustrated embodiment, rotating tool end 42 includes a shoulder 50 and one or more off-center protrusions 40.

Shoulder 50 may operate to frictionally heat the material of workpiece 12 as rotating tool 30 is rotating. Off-center protrusions 40 may operate to stir the material of workpiece 12. In certain cases, off-center protrusions 40 may stir material of one or more layers of workpiece 12. For example, off-center protrusions 40 may stir material in order to eliminate a boundary between layers 14 and 16 of workpiece 12. An example rotating tool 30 is described in more detail with reference to FIG. 2.

Modifications, additions, or omissions may be made to welding apparatus 10 without departing from the scope of the invention. The components of welding apparatus 10 may be integrated or separated according to particular needs. Moreover, the operations of welding apparatus 10 may be performed by more, fewer, or other components. Additionally, operations of welding apparatus 10 may be performed using any suitable device, mechanism, structure, or any suitable combination of the preceding.

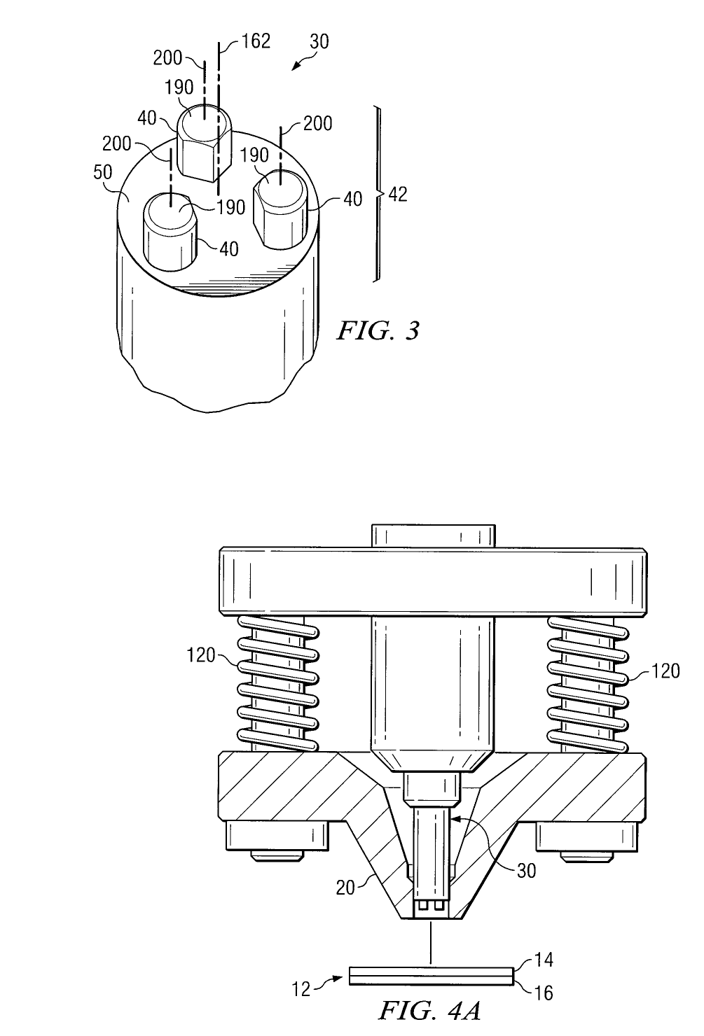

FIG. 3 is an illustration of an example rotating tool 30 that may be used with welding apparatus 10 of FIG. 2, in accordance with an embodiment of the invention. In the illustrated embodiment, rotating tool 30 has a rotation axis 162 about which rotating tool 30 rotates, and includes a rotating tool end 42 with one or more off-center protrusions 40 and shoulder 50.

Shoulder 50 may operate as described with reference to FIG. 2. Shoulder 50 may have any suitable surface to frictionally heat the material of workpiece 12. In one embodiment, shoulder 50 may have a substantially flat surface that may provide maximum contact with workpiece 12. In other embodiments, shoulder 50 may be curved or slanted at an angle. In other embodiments, shoulder 50 may have a rough texture that may increase the rate of frictional heating.

Off-center protrusions 40 may operate as described with reference to FIG. 2. An off-center protrusion 40 may refer to any structure protruding from rotating tool end 42. An off-center protrusion 40 has a protrusion end 190 and a protrusion axis 200. Protrusion end 190 represents the surface at the end of the protrusion 40. Protrusion axis 200 runs along the centerline of the protrusion 40.

An off-center protrusion 40 is generally not centered about a point formed by the intersection of rotation axis 162 and rotating tool end 42. That is, protrusion axis 200 is generally not coincident with rotation axis 162. Rotating tool end 42, however, may include a centered protrusion without departing from the scope of the invention.

An off-center protrusion 40 may have any suitable size or shape. As an example, a protrusion axis 200 may or may not be parallel to rotation axis 162. In certain embodiments, protrusion axis 200 may be oriented to facilitate the release of rotating tool 30 from workpiece 12. For example, protrusion axis 200 may be angled in the direction of the flow of material.

As another example, an off-center protrusion 40 may have any suitable cross sectional shape, such as circular or polygonal. In certain embodiments, a cross sectional shape that reduces friction between off-center protrusions 40 and the displaced material may be selected. For example, the cross sectional shape may be selected to be fluid dynamic. As yet another example, a protrusion end 190 may have any suitable shape. In the illustrated embodiment, protrusion end 190 is flat. In other embodiments, protrusion end 190 may be curved.

Modifications, additions, or omissions may be made to rotating tool 30 without departing from the scope of the invention. The components of rotating tool 30 may be integrated or separated according to particular needs. Moreover, the operations of rotating tool 30 may be performed by more, fewer, or other components. Additionally, operations of rotating tool 30 may be performed using any suitable device, mechanism, structure, or any suitable combination of the preceding.

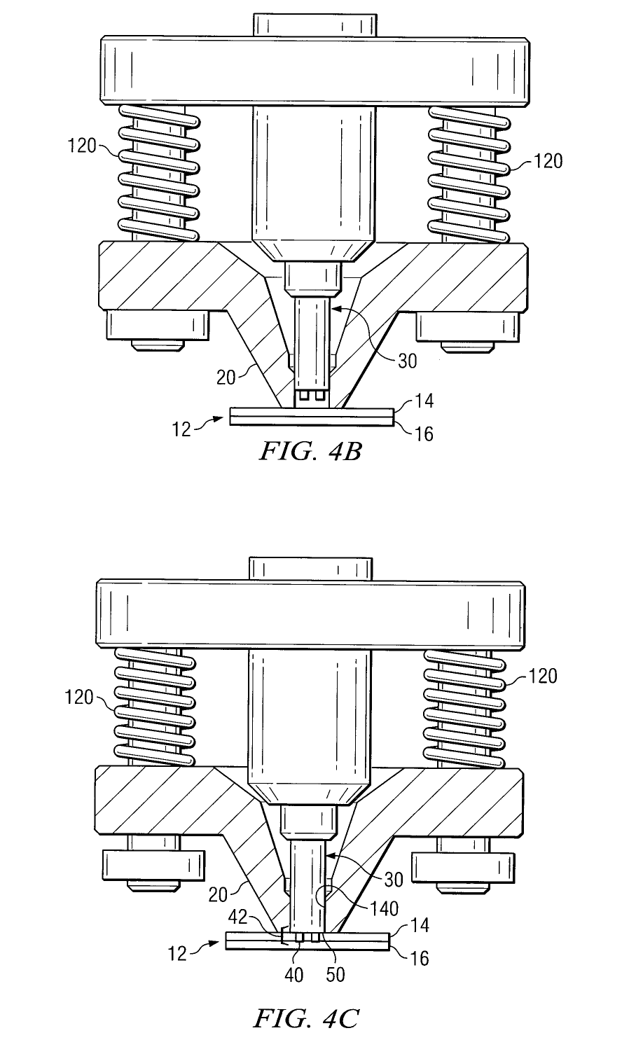

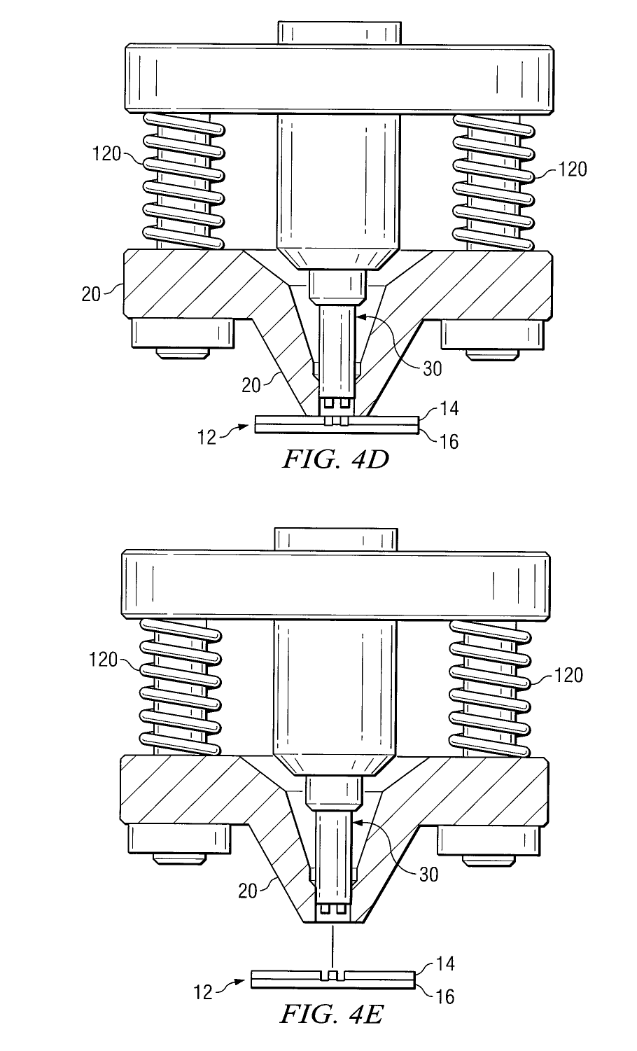

FIG. 4 is an illustration of a method of friction stir spot welding that may be used by the welding apparatus of FIG. 2, in accordance with an embodiment of the invention.

The method begins at step A, where welding head 20 and rotating tool 30 move towards workpiece 12. Welding head 20 comes into contact with layer 14 of workpiece 12 at step B. Force mechanisms 120 compress, and rotating tool 30 continues to move towards workpiece 12.

Off-center protrusions 40 penetrate the material of workpiece 12 and shoulder 50 comes in contact with surface of workpiece 12 at step C. As rotating tool 30 rotates, shoulder 50 frictionally heats the material. Off-center protrusions 40 stir the material of the workpiece 12 to eliminate the boundary between layers 14 and 16 to form a spot weld. In some embodiments, recessed portion 140, rotating tool end 42, and workpiece 12 may contain the displaced material. Volumetric deformation near protrusions 40 may also generate heat. Parameters may be adjusted such that the ratio of frictional to deformation-induced heating is smaller for thicker workpieces.

After the spot weld is formed, rotating tool 30 moves away from workpiece 12 at step D. Force mechanisms 120 may expand to move rotating tool 30 away from workpiece 12. Rotating tool 30 may move away from workpiece 12 in any suitable manner. In a first mode, the rotation of rotating tool 30 may continue during removal of rotating tool 30 from workpiece 12. Continuing rotation may require less additional force to separate rotating tool 30 from workpiece 12. In a second mode, the rotation of rotating tool 30 may be stopped prior to removal of rotating tool 30 from workpiece 12. Stopping rotation may allow for reduced removal of displaced material from workpiece 12, which may yield a stronger weld.

Welding head 20 is released from workpiece 12 at step E. In some embodiments, a mechanical bond may be formed between workpiece 12 and welding head 20 by the displaced material. In one embodiment, welding head 20 may rotate as it moves away from workpiece 12 to break the bond. The method then terminates.

Modifications, additions, or omissions may be made to the method without departing from the scope of the invention. The method may include more, fewer, or other steps. Additionally, steps may be performed in any suitable order without departing from the scope of the invention.

Certain embodiments of the invention may provide one or more technical advantages. A technical advantage of an embodiment may be that a welding apparatus includes a rotating tool with off-center protrusions. The off-center protrusions may increase the contact area between the rotating tool and the workpiece, which may allow for faster plasticization of displaced workpiece material. The off-center protrusions may also increase the volume of bonded material common to both of the elements which are welded, resulting in a weld with improved mechanical properties.

Another technical advantage of an embodiment may be that a welding head of the welding apparatus may rotate during removal of the welding apparatus from the workpiece. Rotating the welding head may break a mechanical bond formed between the welding head and the workpiece by displaced material, which may allow for easier removal. Another technical advantage of an embodiment may be that the welding head may be used to flatten the weld to yield a lower profile weld.

Another technical advantage of an embodiment may be that rotation of the rotating tool may continue during removal of the rotating tool from the workpiece. Continuing rotation may require less additional force to separate the rotating tool from the workpiece. Another technical advantage of an embodiment may be that rotation of the rotating tool may be stopped prior to removal of the rotating tool from the workpiece. Stopping rotation may reduce removal of displaced material from the workpiece, which may yield a stronger weld.

Numerous other changes, substitutions, variations, alterations, and modifications may be ascertained by those skilled in the art. The present invention encompasses all such changes, substitutions, variations, alterations, and modifications as falling within the spirit and scope of the appended claims.

What is claimed is:

1. An apparatus for welding a workpiece, comprising:
a welding head having a recessed portion and a welding head end, the welding head end operable to be placed in contact with a surface of a workpiece; and
a rotating tool disposed within the recessed portion of the welding head, the rotating tool operable to rotate about an axis, the rotating tool operable to translate along the axis, the rotating tool comprising a rotating tool end operable to be placed in contact with material of the workpiece, the rotating tool end comprising:
a shoulder having a surface operable to frictionally heat the material of the workpiece; and
one or more off-center protrusions, an off-center protrusion operable to penetrate and displace the material of the workpiece to form a weld.

2. The apparatus of claim 1, further comprising:
a force mechanism operable to apply force to the welding head to increase pressure between the welding head and the workpiece.

3. The apparatus of claim 1, further comprising:
one or more springs operable to apply force to the welding head to increase pressure between the welding head and the workpiece.

4. The apparatus of claim 1, further comprising:
a force mechanism operable to compress to facilitate movement of the rotating tool end towards the workpiece.

5. The apparatus of claim 1, wherein the displaced material of the workpiece is substantially contained by the recessed portion of the welding head, the rotating tool end, and the workpiece.

6. The apparatus of claim 1, wherein a protrusion of the one or more protrusions has a protrusion end operable to be placed in contact with the material of the workpiece, the protrusion end having a circular cross section.

7. The apparatus of claim 1, wherein a protrusion of the one or more protrusions has a shape operable to reduce friction between the protrusion and the material displaced by the protrusion.

8. The apparatus of claim 1, wherein the welding head is operable to rotate about the axis.

9. The apparatus of claim 1, wherein the welding head is operable to strike the weld.

10. An apparatus for welding a workpiece, comprising:
a welding head having a recessed portion and a welding head end, the welding head end operable to be placed in contact with a surface of a workpiece;
a rotating tool disposed within the recessed portion of the welding head, the rotating tool operable to rotate about an axis, the rotating tool operable to translate along the axis, the rotating tool comprising a rotating tool end operable to be placed in contact with material of the workpiece, the rotating tool end comprising:
a shoulder having a surface operable to frictionally heat the material of the workpiece; and
one or more off-center protrusions, an off-center protrusion operable to penetrate and displace the material of the workpiece to form a weld, the displaced material of the workpiece substantially contained by the recessed portion of the welding head, the rotating tool end, and the workpiece, a first protrusion of the one or more protrusions having a protrusion end operable to be placed in contact with the material of the workpiece, the protrusion end having a circular cross section, a second protrusion of the one or more protrusions having a shape operable to reduce friction between the protrusion and the material displaced by the protrusion; and
a force mechanism comprising one or more springs and operable to:
apply force to the welding head to increase pressure between the welding head and the workpiece; and
compress to facilitate movement of the rotating tool end towards the workpiece;
the welding head further operable to:
rotate about the axis; and
strike the weld.

11. A method of welding a workpiece, comprising:
placing a welding head end of a welding head in contact with material of a workpiece, the welding head having a recessed portion;
placing a shoulder of a rotating tool end of a rotating tool in contact with the material of the workpiece, the rotating tool disposed within the recessed portion of the welding head;
frictionally heating the material of the workpiece using the shoulder; and
displacing the material of the workpiece with one or more off-center protrusions of the rotating tool end to form a weld.

12. The method of claim 11, further comprising:
applying force to the welding head to increase pressure between the welding head and the workpiece.

13. The method of claim 11, further comprising:
compressing a force mechanism to facilitate movement of the rotating tool end towards the workpiece.

14. The method of claim 11, further comprising:
substantially containing the displaced material by the recessed portion, the rotating tool end, and the workpiece.

15. The method of claim 11, further comprising:
stopping rotation of the rotating tool; and
moving the rotating tool away from the workpiece.

16. The method of claim 11, further comprising:
continuing rotation of the rotating tool; and
moving the rotating tool away from the workpiece.

17. The method of claim 11, further comprising:
rotating the welding head; and
moving the welding head away from the workpiece.

18. The method of claim 11, further comprising:
moving the welding head away from the workpiece;
rotating the welding head; and
striking the weld with the welding head.

19. A system of welding a workpiece, comprising:
means for placing a welding head end of a welding head in contact with material of a workpiece, the welding head having a recessed portion;
means for placing a shoulder of a rotating tool end of a rotating tool in contact with the material of the workpiece, the rotating tool disposed within the recessed portion of the welding head;
means for frictionally heating the material of the workpiece using the shoulder; and
means for displacing the material of the workpiece with one or more off-center protrusions of the rotating tool end to form a weld.

20. A method of welding a workpiece, comprising:
placing a welding head end of a welding head in contact with material of a workpiece, the welding head having a recessed portion;
compressing a force mechanism to facilitate movement of a rotating tool end of a rotating tool towards the workpiece, the rotating tool disposed within the recessed portion of the welding head;
placing a shoulder of the rotating tool end in contact with the material of the workpiece;
frictionally heating the material of the workpiece using the shoulder;
displacing the material of the workpiece with one or more off-center protrusions of the rotating tool end to form a weld;
applying force to the welding head to increase pressure between the welding head and the workpiece;
substantially containing the displaced material by the recessed portion, the rotating tool end, and the workpiece;
performing at least one of the following:
stopping rotation of the rotating tool; and
continuing rotation of the rotating tool;
moving the rotating tool away from the workpiece;
rotating the welding head;
moving the welding head away from the workpiece;
rotating the welding head; and
striking the weld with the welding head.
